(19) United States
(12) Patent Application Publication
(10) Pub. No.: US 2007/0263111 A1
(43) Pub. Date: Nov. 15, 2007

(54) Solid-state image pickup device capable of compensating for vertical shading caused by dark current

(75) Inventor: Yoshihiro Satodate, Asaka-shi (JP)

Correspondence Address: BIRCH STEWART KOLASCH & BIRCH, PO BOX 747, FALLS CHURCH, VA, 22040-0747, US

(73) Assignee: FUJIFILM Corporation

(21) Appl. No.: 11/790,864

(22) Filed: Apr. 27, 2007

(30) Foreign Application Priority Data
Apr. 28, 2006 (JP) 2006-126415

(51) Int. Cl. H04N 5/335

(52) U.S. Cl. 348/311

(57) ABSTRACT

A digital camera has a system controller for generating a control signal for idle transfer in vertical transfer paths in addition to image data transfer, according to photographing status and conditions. The camera further includes a signal processor having a vertical shading corrector for determining the profile of vertical shading based on a dark current signal obtained by the idle transfer from the solid state image sensor of an image pickup section of the camera. The profile of vertical shading thus obtained is used for correcting the data of an image actually picked up. Deterioration of images caused by the dark current can be reduced, and the image quality of the images and the operational speed of the camera can be increased.

### BACKGROUND OF THE INVENTION

1. Field of the Invention

The present invention relates to a solid-state image pickup device, and more specifically to a solid-state image pickup device for compensating for vertical shading caused by dark current for use in a digital camera, image input device, mobile telephone, etc.

2. Description of the Background Art

Generally when an image is picked up by a CCD (Charge-Coupled Device) or CMOS (Complementary Metal Oxide Semiconductor) image pickup device, etc., shading occurs in horizontal and vertical directions caused by the circuit noise dependent on dark noise caused by dark current, fluctuation of power supply and dispersion of the image pick up device. The shading deteriorates the image quality of picked up image data. Considerably large effect of dark noise appears especially in photographing in dark places and in long exposures. Compensation is carried out for image data obtained under such photographing conditions.

U.S. Pat. No. 5,729,288 to Saito teaches an electronic image pickup device, which photographs by capturing the image of an object with image data of dark exposure obtained, and subtracts the dark exposure data from the image data of the object to compensate for the dark current component to establish final image data. Sato also discloses storing noise data specific to pixel in a nonvolatile memory. Japanese Patent Laid-Open Publication No. 251484/1996 teaches an image pickup device in which image data of dark exposure is stored in a RAM (Random Access Memory), and data of pixel defects stored in a ROM (Read-Only Memory) and the dark exposure data thus stored are used to correct image data captured. Japanese '484 publication teaches that electric charge generated in an optically shielded state for each photographic exposure is accumulated for using the dark exposure data as noise data.

Another Japanese Patent Laid-Open Publication No. 2000-299817 teaches a solid-state image pickup device, which employs, in order to suppress dark current and smear, at least one line of empty packets when reading out pixels in vertical direction, in other words, adds empty packets after signal data to form noise data. The prepared noise data is output in the preset phase. At this time, the solid-state image pickup device subtracts a component to be suppressed from the image data component to achieve a good quality of image data. The conventional image pickup devices thus prepare noise data by means of various methods for use in operating data of captured image with the prepared noise data to correct the image.

However, the dark noise differs in dependent upon photographing environment and conditions. Circuit noise also is also affected to at least the similar extent. Therefore, a mere storage of noise data in a nonvolatile memory does not allow photographing successfully under various conditions and a memory has to be used which has its storage capacity larger than required for storing image data.

When acquiring dark exposure data such as in Japanese '484 publication, since an imaging period of time simply becomes double, there is a problem of degradation for a series of continuous exposures. Japanese '817 publication involves no difficulty in memory means and photographing time prolongation. However, in this solid-state image pickup device reset signals have to be provided for the respective preset and data phases. For this reason, in such a solid-state image pickup device the reset noise is different between the preset and data phases. As a result, this solid-state image pickup device raises a problem that the reset noise cannot be removed by CDS (Correlated-Double Sampling).

### SUMMARY OF THE INVENTION

It is an object of the present invention to provide a solid-state image pickup device capable of compensating for dark noise that may differ in dependent upon photographing environment and conditions.

In accordance with the present invention, an image pickup device comprises a solid-state image sensor including a bi-dimensional array of photosensitive cells for photo-electrically converting incident light from an object field to corresponding signal charge, a vertical transfer path adjacent to the photosensitive cells for transferring the signal charge in a vertical direction, and a horizontal transfer path for transferring the signal charge in a horizontal direction substantially perpendicular to the vertical direction; a controller for generating a control signal for controlling operation of said solid-state image sensor; a timing generator for generating a timing signal in response to the control signal; a drive generator for generating a drive signal in response to the timing signal; and a signal processor for processing of image data supplied from said solid-state image sensor, said controller generating the control signal for reading out the signal charge from said solid-state image sensor according to at least either one of a photographing condition and status, and controlling idle transfer in said vertical transfer paths and transfer of the signal charge, said signal processor including a shading corrector for determining a profile of vertical shading based on a dark current signal obtained by the idle transfer from said solid-state image sensor, said shading corrector using the profile of vertical shading determined to correct data of an image actually captured.

A solid-state image pickup device according to the present invention includes a system controller for generating a control signal for idle transfer in vertical transfer paths in addition to image data transfer, according to photographing status and conditions. The image pickup device further includes a signal processor having a vertical shading corrector for determining the profile of vertical shading based on a dark current signal obtained by the idle transfer from the solid state image sensor of an image pickup section of the image pickup device. The profile of vertical shading thus obtained is used for correcting the data of an image actually picked up. Deterioration of images caused by the dark current can be reduced, and the image quality of the images and the operational speed of the image pickup device can be increased.

### BRIEF DESCRIPTION OF THE DRAWINGS

The objects and features of the present invention will become more apparent from consideration of the following detailed description taken in conjunction with the accompanying drawings in which:

FIG. 1 is a schematic block diagram showing a preferred embodiment of a digital camera incorporating a solid-state image pickup device in accordance with the present invention;

FIGS. 2A, 2B and 2C are schematic views useful for understanding the principle of dark current and a solid-state image sensor used in an image pickup section shown in FIG. 1;

FIG. 3 is a timing chart useful for understanding the operation in the order of image data transfer and idle transfer in the digital camera shown in FIG. 1;

FIG. 4 is a timing chart useful for understanding the operation in the order of idle transfer and image data transfer in the digital camera shown in FIG. 1;

FIG. 5 is a timing chart useful for understanding the operation in the order of idle transfer and image data transfer in the digital camera shown in FIG. 1;

FIG. 6 is a flowchart chart useful for understanding an operation of compensating for dark current in the embodiment of the digital camera shown in FIG. 1;

FIG. 7 is a flowchart useful for understanding an alternative operation of compensating for dark current of the illustrative embodiment shown in FIG. 1;

FIG. 8 is a flowchart useful for understanding a further alternative operation of compensating for dark current of the illustrative embodiment;

FIG. 9 is a flowchart useful for understanding a still alternative operation of compensating for dark current of the illustrative embodiment;

FIG. 10 is a flowchart useful for understanding a still further alternative operation of compensating for dark current of the illustrative embodiment;

FIG. 11 is a timing chart useful for understanding the operation of transfer in the order of image data transfer and idle transfer with the period of time for idle transfer reduced in the digital camera shown in FIG. 1;

FIG. 12 is a graph plotting the dark current generated by the idle transfer and the image data transfer in the digital camera shown in FIG. 11;

FIG. 13 is a timing chart useful for understanding the operation of transfer in the order of image data transfer and idle transfer with the period of time for idle transfer reduced in the digital camera shown in FIG. 1; and

FIG. 14 is a graph plotting the dark current generated by the idle transfer and the image data transfer in the digital camera shown in FIG. 13.

### DESCRIPTION OF THE PREFERRED EMBODIMENT

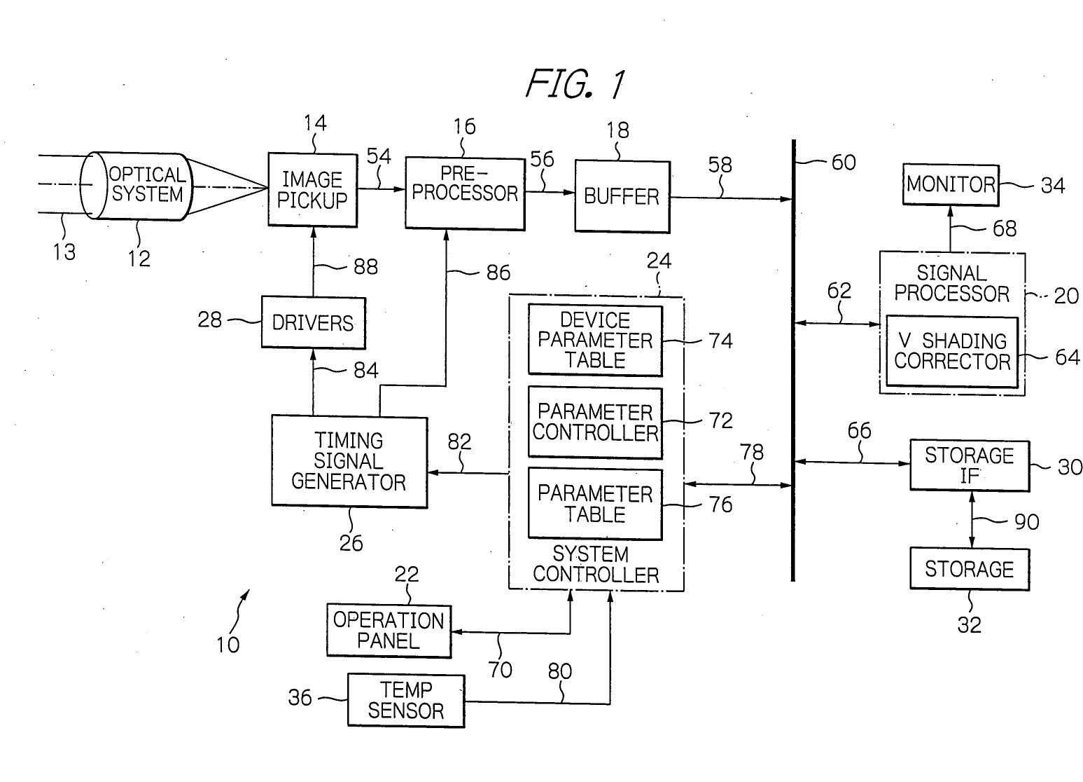

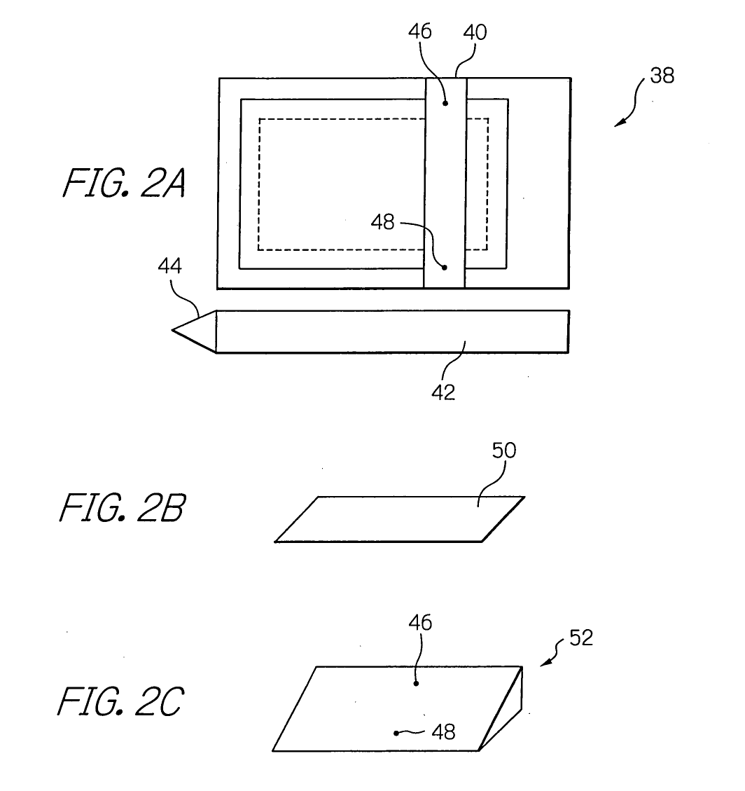

With reference to the accompanying drawings, a preferred embodiment of the solid-state image pickup device will be described in detail according to the present invention. Referring first to FIG. 1, an illustrative embodiment of an image pickup device according to the present invention includes a system controller 24 for generating a control signal 82 to cause image data transfer and, in addition, idle transfer of vertical transfer paths in dependent upon photographing, or image shooting, conditions and status, and a signal processor 20 including a vertical shading corrector 64, which is adapted to use a dark current signal obtained through the idle transfer from a solid-state image sensor 38, FIG. 2A, of an image pickup section 14 to determine a profile or shape of vertical shading and compensate for data of actually captured images with the profile of vertical shading thus determined, thereby improving the quality of images which would otherwise be deteriorated by the dark current and the speed of image processing on shading.

The illustrative embodiment is directed to a digital camera 10, to which applied is the solid-state image pickup device according to the present invention. Parts or components not directly relevant to understanding the present invention will not be shown nor described.

As shown in FIG. 1, the digital camera 10 comprises an optical system 12, an image pickup section 14, a pre-processor 16, a buffer memory 18, a signal processor 20, an operation panel 22, a system controller 24, a timing signal generator 26, drivers 28, a storage interface (IF) circuit 30, a storage 32, a monitor display 34 and a temperature sensor 36, which are interconnected as illustrated.

The optical system 12 possesses the function of focusing incident light 13 from an object field onto the image pickup section 14 to form an image of the object in response to operation of the operation panel 22. The optical system 12 adjusts its angle of view and focal length in response to a zooming operation and a half-stroke depression of a shutter release button, not shown, of the operation panel 22.

The image pickup section 14 has a solid-state image sensor 38, FIG. 2A, which is arranged on the side of incident light 13 and has color filter segments arranged thereon corresponding to the position of photosensitive cells of the sensor. The solid-state image sensor 38 possesses the function of receiving separated color components of the incident light 13 and converting by the photosensitive cells the quantity of the separated color components into corresponding electric signal charges having the attribute thereof corresponding to color to output them in the form of electric signals 54. In the following description, signals are designated with the reference numerals of connections on which they are conveyed.

As shown in FIG. 2A, the solid-state image sensor 38 is of a single board or chip having its photosensitive cells arranged to cope with the filter segments of three-primary colors, red “R”, green “G” and blue “B”. The solid-state image sensor 38 performs photoelectric conversion by the photosensitive cells according to exposure to generate and accumulate corresponding signal charges, and reads out the signal charges thus accumulated to vertical transfer paths 40 on which they are sequentially transferred in the vertical direction in the figure. Although the image sensor 38 has a lot of vertical transfer paths in practice, FIG. 2A simply shows one vertical transfer path 40 just for simplicity. The vertically transferred signal charges are supplied to a horizontal transfer path 42 substantially perpendicular to the vertical transfer paths 40. The horizontal transfer path 42 transfers the signal charges towards its output amplifier 44. The output amplifier 44 converts the signal charges thus supplied with floating diffusion amplification to an analog voltage signal and outputs the latter.

Next, a simple description will be given regarding operation of the solid-state image sensor 38. The solid-state image sensor 38 shown in FIG. 2A performs interlace readout of reading out the signal charges accumulated from alternative half of the photosensitive cells arranged in its effective pixel area for each field to the vertical transfer paths 40 and vertically transfers the signal charges thus read out.

Well, description will be made regarding the principle of vertical shading caused by dark current on vertical transfer paths 40. When there is no dark current ideally, the quantity of dark current may be represented by a uniform plane 50 as shown in FIG. 2B whereas in practice the solid -state image sensor 38 involves dark current which increases with time. Between upper and lower positions 46 and 48, the time required for the signal charges to reach the horizontal transfer path 42 is different. From the proportionality of dark current and the time difference, the generated dark current accumulates in larger amount, shown in FIG. 2C, in the distal position 46 from the horizontal transfer path 42 whereas in less amount in the proximal position 48. As a result, the amount of the dark current in the vertical transfer paths 40 maybe represented in FIG. 2C by an inclined solid body 52 having its inclination or gradient fixed or variable. This shows that shading occurs in the vertical direction in a frame of image captured. Specifically, the dark current is likely to generate at higher temperature and higher optical sensitivity setting, such as the ISO (International Organization for Standardization) sensitivity, and affects image quality.

Referring back to FIG. 1, the image pickup section 14 outputs an analog signal 54 from the solid-state image sensor 38 to the pre-processor 16.

The pre-processor 16 possesses an analog front-end (AFE) function. This function reduces for noise components included in the analog signal 54 by a correlated-double sampling (CDS) and digitizes, i.e. analog-to-digital (A/D)-converts, the analog electric signal with noise components thus reduced. The pre-processor 16 outputs the digitized image data 56 to the buffer memory 18. The buffer memory 18 possesses the function of temporarily storing the supplied image data 56. The buffer memory 18 outputs the stored image data 58 onto a bus 60 and a signal line 62 to the signal processor 20.

The signal processor 20 possesses the function of compensating for a vertical shading involved in the supplied image data 62. The signal processor 20 includes a vertical shading corrector 64. The vertical shading corrector 64 is adapted to set the data obtained by idle transfer as vertical shading data and subtract from the image data 62 a dark current component which is based on the proportional relationship 52 of the vertical shading data thus set with the position of pixels in the effective imaging area to thereby compensate for the vertical shading. Methods of determining vertical shading data, conditions and compensation will further be described later on.

The signal processor 20 possesses the function of interpolating the image data thus corrected to thereby synchronize the data, and converting the interpolated and synchronized data to aluminance/chrominance (Y/C) signal. The signal processor 20 also possesses the function of converting the produced Y/C signal to, for example, a signal compatible with an LCD (Liquid-Crystal Display) monitor, which is applicable to the display monitor 34. In addition, the signal processor 20 possesses the function of compressing the Y/C signal and expanding the compressed signal to restore the original signal for reproduction according to a recording mode. The recording-mode may be JPEG (Joint Photographic Experts Group), MPEG (Moving Picture Experts Group) and raw data mode, etc. The signal processor 20 supplies the image data thus processed in a recording mode from the signal line 62 to the bus 60 and further to the storage interface circuit 30. In addition, the signal processor 20 outputs a signal 68 appropriate for an LCD type of display monitor to the monitor 34.

The operation panel 22 includes a power witch, a zoom button, a menu indication selector switch, a selector or decision key, a movie mode setter, a continuous shooting speed setter and a shutter release button, although not specifically shown. Specifically, the shutter release button possesses the function of being responsive to depression to its half or full stroke to issue a signal 70 defining the operational timing and mode of the digital camera 10. The shutter release button, when depressed to its half stroke, allows the camera 10 to control automatic exposure (AE) and automatic focusing (AF) operations. Those operations use image data captured in movie to determine an appropriate aperture value, shutter speed and focusing distance. The shutter release button, when depressed to its full stroke, produces a timing signal defining the timing of starting and ending recording to send it to the system controller 24, thus providing the circuitry of the digital camera 10 with the timing according to a mode set in the camera 10. Modes to be set may include still picture and movie recording modes. The operation panel 22 supplies the operation indication signal 70 to the system controller 24.

The system controller 24 possesses the function of generating various kinds of control signal in response to the operation indication signal 70 from the operation panel 22. The system controller 24 possesses the function of generating a control signal defining timings for operations including idle transfer according to parameter conditions for photographing. In order to accomplish those functions, the system controller 24 specifically includes a parameter controller 72, a device parameter table 74 and a parameter table 76, as seen from FIG. 1. In the system controller 24, an integration value is supplied from an integrator, not shown, of the signal processor 20 to the parameter controller 72 and the parameter table 78 over the signal line 62, the bus 60 and a signal line 78. The parameter table 76 includes a programmed diagram, which is consulted with by an integration value supplied so as to selectively determine an appropriate parameter value to be used. The device parameter table 74 stores set information and threshold values, such as ISO sensitivities, indications of flashing or not and power saving or not, threshold values until starting power saving and data amount of a frame of image, set on the digital camera 10. The set threshold values may include ones for sensitivity, temperature and inclination of an idle transfer property, which will be described later. The system controller 24 is supplied with information 78 on a sensed temperature from the temperature sensor 36. The system controller 24 possesses the function of determining the temperature of the solid-state image sensor 38 or the internal temperature of the digital camera 10 based on the temperature information 80 thus supplied.

The parameter controller 72 functions as making a decision on the basis of supplied parameter values, such as exposure and shutter speed, device parameter and temperature values, to generate a control signal 82 according to the decision. The system controller 24 outputs the generated control signal 82 to the timing signal generator 26. The system controller 24 also outputs the generated control signal 78 to the storage interface circuit 30 and the signal processor 20 over the bus 60.

The timing signal generator 26 possesses the function of generating various timing signals such as vertical and horizontal synchronous signals, a field shift gate signal, vertical and horizontal timing signals and an OFD (Over-Flow Drain) signal for use in the image pickup section 14. This function is also responsive to the supplied control signal 82 to generate various timing signals 84 depending to sensitivity and temperature values and a scanning scheme in the drive mode. The timing signal generator 26 outputs the timing signal 84 to the drivers 28. The timing signal generator 26maybe adapted to be responsive to the control signal 82 supplied thereto to generate the timing signal 84 having its drive frequency dependent upon the type of charge transfer, the vertical or idle transfer in a field. The timing signal generator 26 also supplies a sampling signal 86 to pre-processor 16.

The drivers 28 serve as using the timing signal 84 supplied to, for example, generate vertical and horizontal drive signals 88. The drivers 28 supply vertical and horizontal drive signals 88 to the image pickup section 14.

The storage interface circuit 30 possesses the interface control function to control recording and reproduction of image data according to, for example, recording media used. The storage interface circuit 30 can control write and read of image data on a PC (Personal Computer) card, that is, semiconductor recording medium, although not shown, and can control writing and reading of data through a USB (Universal Serial Bus) controller, if installed. To the storage 32, applicable are various kinds of memory medium satisfying semiconductor storage card specifications.

The display monitor 34 employs an LCD monitor, etc., with the illustrative embodiment. The monitor 32 visualizes image data 68 supplied from the signal processor 20 in the form of picture and the status and indications of the digital camera 10, if appropriate.

The temperature sensor 36 is a device for providing temperature information 80. For example, the temperature sensor 36 may be a temperature sensor, or a circuit adapted for measuring the amount of dark current caused in an optical black (OB) area formed on the image pickup surface, or bi-dimensional array of photosensitive cells, not shown, of the image sensor 38 to detect the temperature to issue temperature information 80.

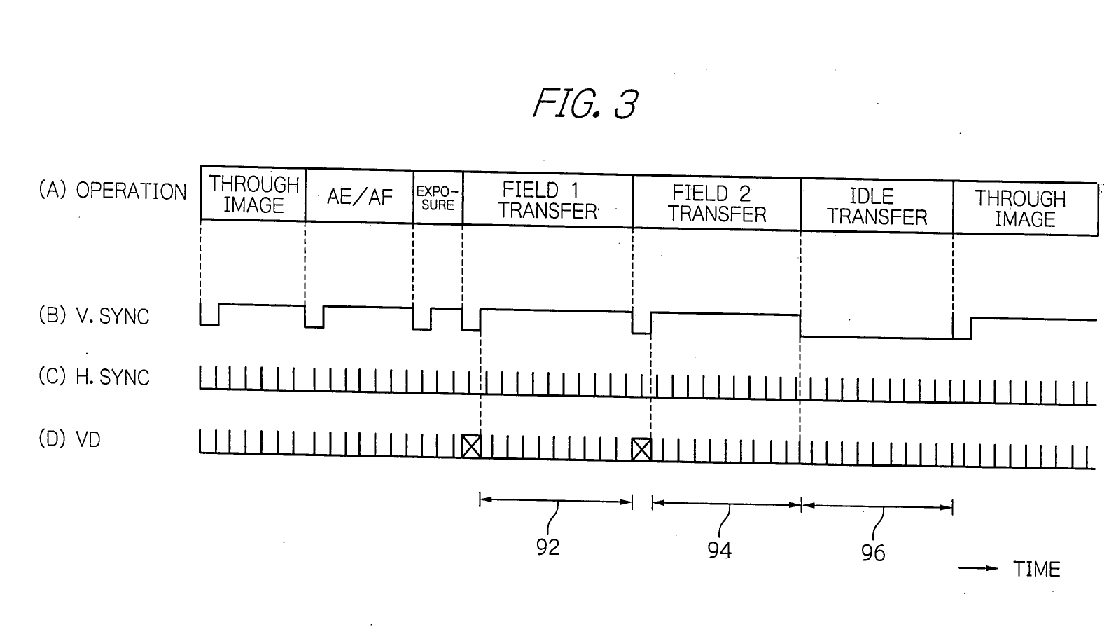

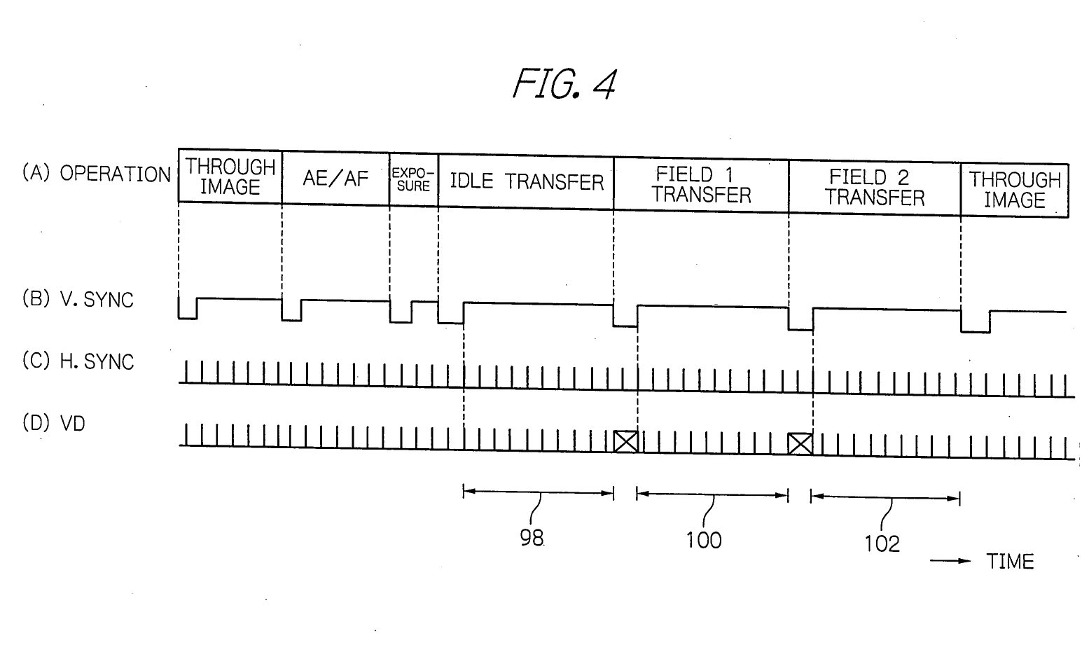

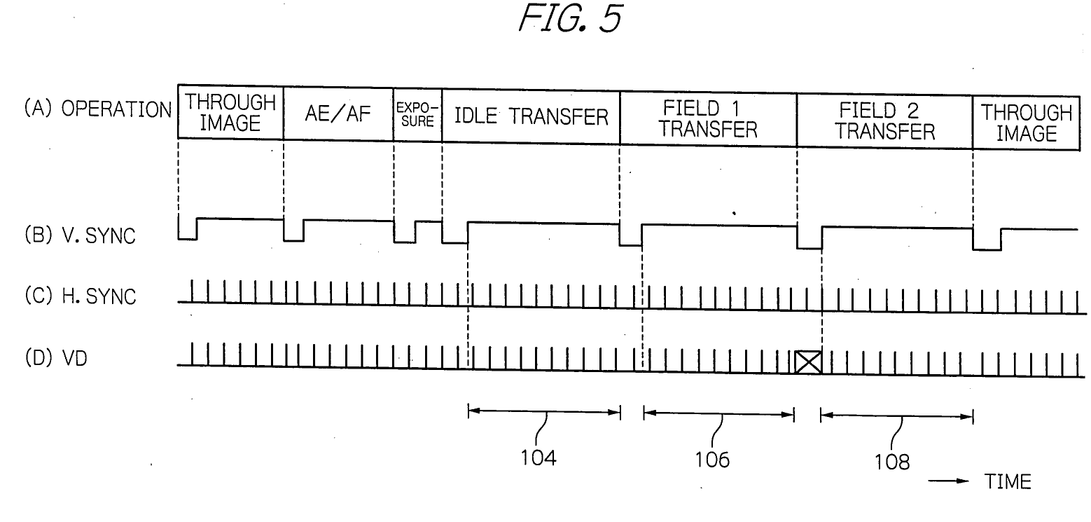

The system configuration thus described enables, for example, the vertical transfer of signal charges and the following idle transfer over the vertical transfer path 40 in substantially the same period of time as the vertical transfer to determine the profile or shape of vertical shading. More specifically, as shown in FIG. 3, the vertical synchronous signals V. Sync, horizontal synchronous signals H. sync, and the vertical drive signals VD are generated according to the operation. From the figure, it can be seen that the field #1 transfer, field #2 transfer and idle transfer in operation include the same number of pulses of horizontal synchronous signal as depicted in time periods 92, 94 and 96, respectively. The same number of pulses means that the time duration is substantially equal to each other. As shown in FIG. 4, even if the sequence of the operation is the idle transfer, the field #1 transfer and the field #2 transfer in turn, it is desirable that the number of horizontal synchronous pulses contained in these three periods of time 98, 100 and 102, respectively, be the same as each other. As shown in FIG. 5, the idle transfer may include sweep out of smear. The same number of pulses is contained in periods 104, 106 and 108. The thus inclusion of the sweep out of smear may shorten the period of time required. Since the dark current depends on a period of time in which signal charges stay in the vertical transfer paths 46, the vertical shading is not affected by whether to expose with incident light 13.

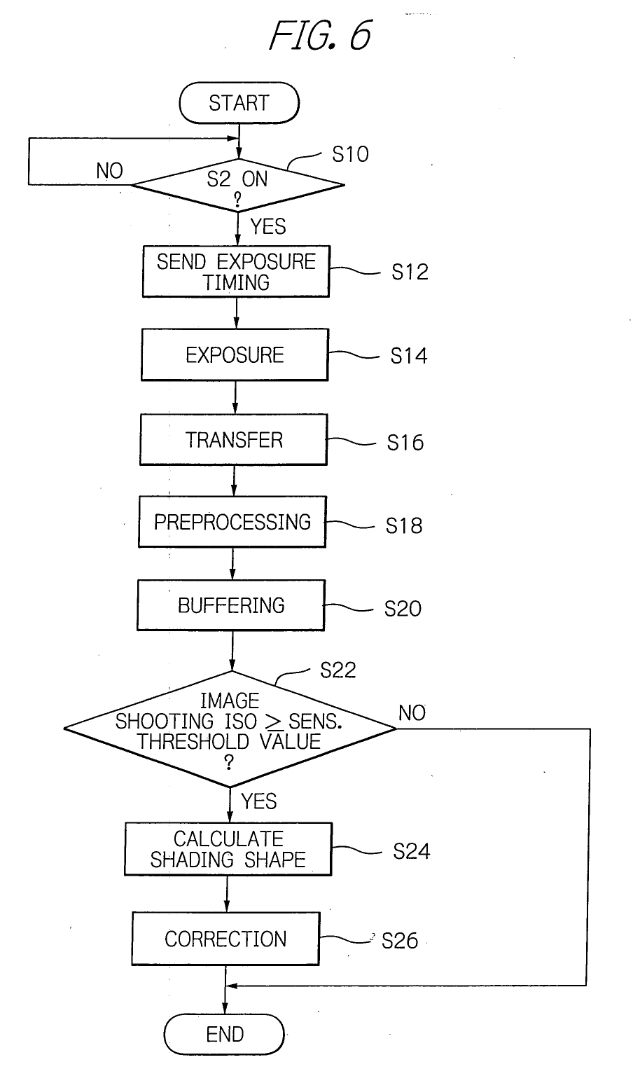

Now, description will be made on the operating procedure of the digital camera 10 of the instant illustrative embodiment. One of the features of the operating procedure is to control whether to perform the idle transfer according to the photographing status and conditions. With reference to FIG. 6, at first it is determined whether or not the shutter release button of the digital camera 10 is depressed to its full stroke, S2 (step S10). If the shutter release button is in its full-stroke depression state S2 (YES), the operation proceeds to step S12 of sending a signal defining exposure timing. If the shutter release button is not in its full-stroke state, S2 (NO), then the operation returns to step S10 of determining whether or not the shutter release button is depressed to its full-stroke.

Thereafter, the exposure timing is sent (step S12). Specifically, the operation panel 22 outputs the operation command signal 70 to the system controller 24. In response, the photosensitive array of the solid-state image sensor 38 is exposed with incident light 13 according to the shutter speed, the aperture value and the parameters obtained by the operation of preliminary image pickup, i.e. the depression of the shutter release button to its half stroke, S1 (step S14). By this exposure, the signal charges dependent upon the amount of light 13 are accumulated in the photosensitive cells that form the image pickup surface.

After that, signal charges are transferred (step S16). The signal charge transfer is carried out in the aforementioned vertical transfer path 40 in the order of, for example, idle transfer, field #1 transfer and field #2 transfer. The signal charges after horizontally transferred are converted to a corresponding analog signal 54. The image pickup section 14 outputs the analog signals 54 to the pre-processor 16.

The analog signals 54 are in turn preprocessed (step S18). On the analog signal 54, noise removal and digitization are sequentially performed by the CDS sampling and the A/D converter, respectively, thereby being converted to the image data 56. After that, the resultant image data 56 is stored in the buffer memory 18 (step S20). The image data of the respective transfers is thus stored in the buffer memory 18.

Thereafter, it is determined whether or not the ISO sensitivity set in the digital camera 10 by the system controller 24, that is, the ISO sensitivity for imaging, is lower than the sensitivity threshold value (step S22). This determination processing is performed because an effect on vertical shading differs according to the ISO sensitivity at the time of photographing. The sensitivity threshold values are kept in the device parameter table 72. The device parameter table 72 may preferably be implemented by an EEPROM (Electrically Erasable Programmable Read-Only Memory). If the ISO sensitivity for imaging is higher than or equal to the sensitivity threshold values (YES), then the operation proceeds to step S24 of calculating or evaluating a profile of vertical shading. If the ISO sensitivity is below the sensitivity threshold values (NO), then the vertical shading is not compensated for, and recording and processing, not shown, of the image are performed, thus the operation coming to end. At a lower ISO sensitivity, imaging is not critically affected by the vertical shading, and hence no compensation is thus made on the vertical shading, so that the processing time can be shortened.

Then, the profile of the vertical shading is calculated (step S24). The profile of vertical shading is calculated by the vertical shading corrector 64 based on the value stored in the buffer memory 18. After the calculation, the vertical shading corrector 64 corrects the values of field #1 transfer and field #2 transfer buffered in the buffer memory 18 (step S26). In the correction processing, the calculated vertical shading correction value is dealt with as a correction amount for read out pixel data of interest according to the vertical position of that pixel, and correction amounts thus obtained are subtracted from data of respectively corresponding pixels. Thereafter, the image and recording processing, not shown, is performed and the operation comes to end. The image processing proceeds according to a mode set. Non-linear image processing may preferably be performed after this correction.

The operation described above renders an appropriate image correction to image data, and consequently the processing depending upon the situations can reduce the time required for the processing.

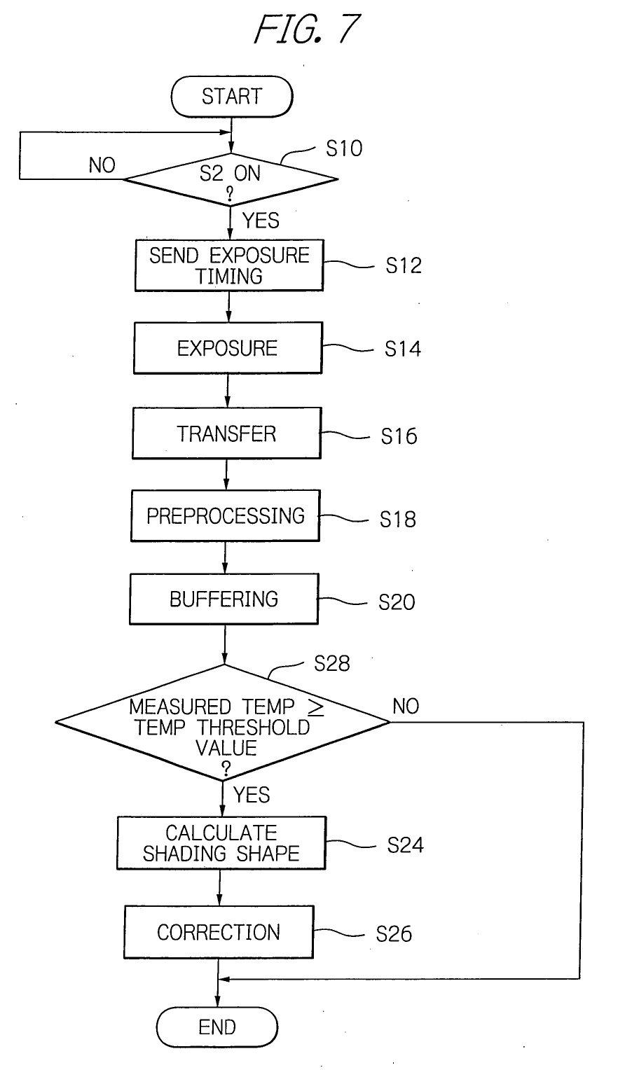

The vertical shading depends on not only the ISO sensitivity at the time of photographing, but also the temperature at the time of photographing. According to the operating procedure shown in FIG. 7, temperature information 80 from the temperature sensor 36 is supplied to the system controller 24. The system controller 24 determines the temperature at the time of photographing based on the temperature information 80. The operating procedure is the same as the operating procedure described with reference to FIG. 6 except the determination processing. In the figures, like components and steps are designated with the same reference numerals, and description thereof will not be repeated merely for simplicity. As shown in FIG. 7, the determination processing of step S28 proceeds to determining whether or not the temperature T measured at the time of photographing is lower than the temperature threshold value.

In step S28, if the determined temperature T is higher than or equal to the temperature threshold values (YES), then the operation proceeds to step S24 of calculating the profile of vertical shading. If the determined temperature T is below the temperature threshold values (NO), the operation proceeds to the normal signal processing flow without compensating for the profile of vertical shading, and ends after the processing. By this determination processing, the time required for the processing can be shortened at a lower temperature, at which the amount of vertical shading is smaller. When the determined temperature is higher than or equal to the temperature threshold values, the digital camera 10 determines the profile of vertical shading (step 24) from the idle transfer data stored in the memory, and performs correction by subtracting, as mentioned above, part corresponding to a dark current from image data (step S26). After performing the correction, the operation proceeds to the normal signal processing flow and comes to end after the processing. By operating in this manner, an appropriate image correction is given to the data of an image, and consequently the processing according to the temperature can reduce the time required for the processing.

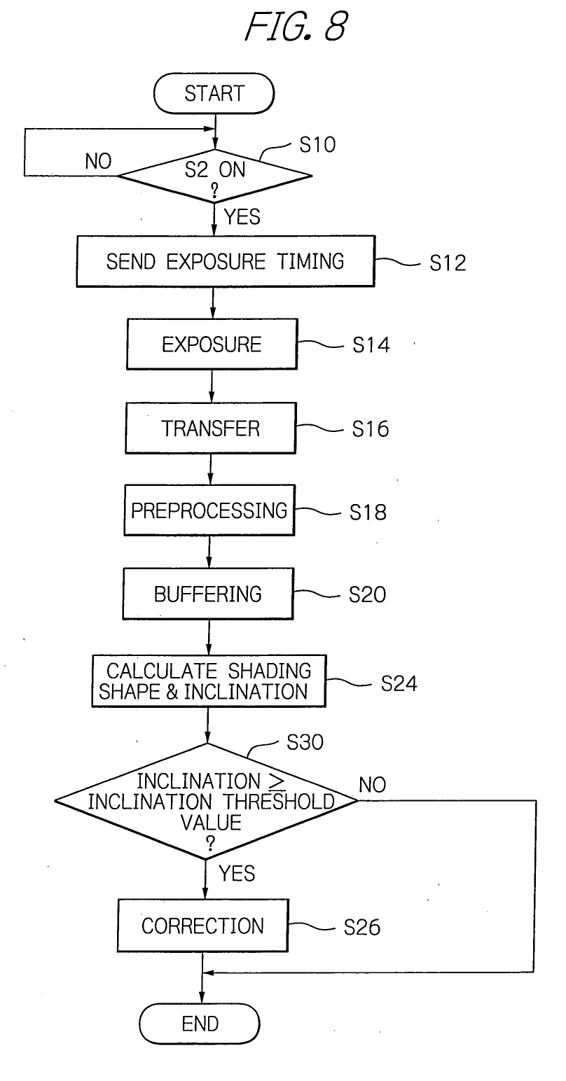

In addition, the determination processing in the operating procedure may also be modified so as to take account of the degree, or certain feature, of the vertical shading. In such a modification, the processing step S24 of calculating the profile of vertical shading following the determination processing in the control flow described with reference to FIG. 6 is performed prior to the determination processing, as shown in FIG. 8. In the determination processing step S30 shown in FIG. 8, it is determined whether or not an inclination or gradient obtained by the idle transfer is lower than a predetermined inclination threshold value. If the inclination is greater than or equal to the predetermined inclination threshold value (YES), then the operation proceeds to step S26 of the correction processing. If the inclination is below the predetermined inclination threshold values (NO), the operation proceeds to the normal signal processing flow without correcting, and comes to end after the processing. The correction is performed by subtracting part corresponding to a dark current from the image data as mentioned before (step S26). After the correction, the operation proceeds to the normal signal processing flow, and comes to end after the processing. By operating in this manner, an appropriate image correction is given to the data of an image, and consequently the processing according to the degree of inclination can also reduce the time required for the processing.

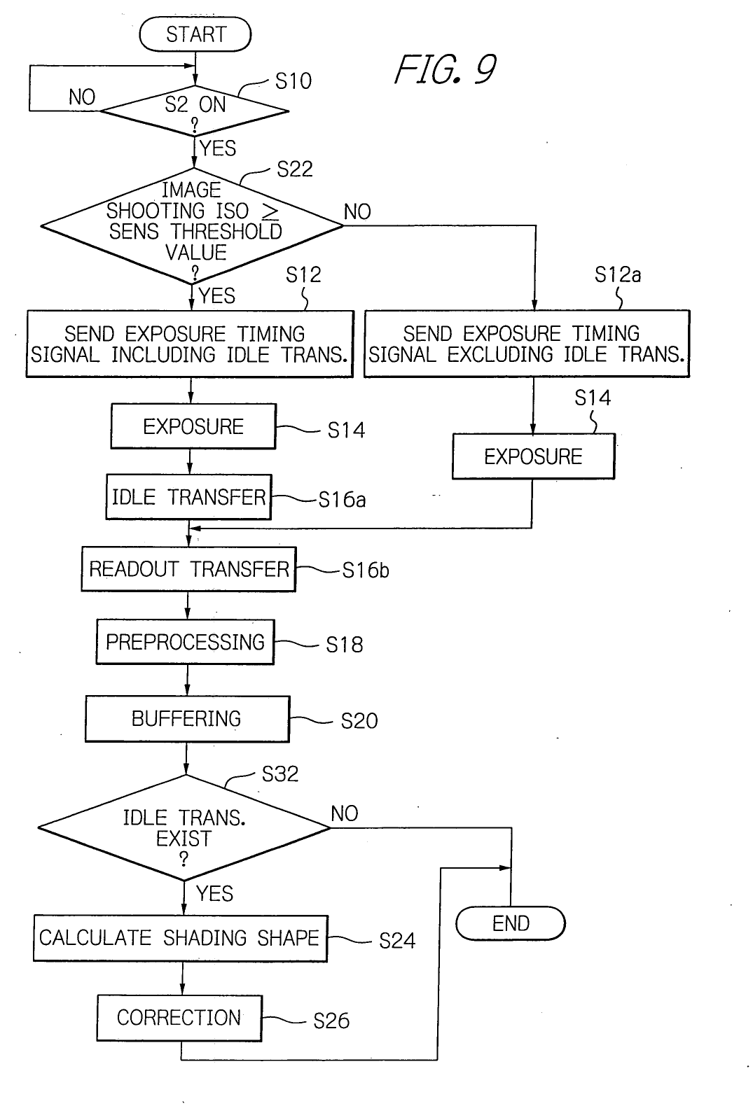

Now, description will be made on a further modification of the operating procedure shown in FIG. 6. In the description, the same reference symbols are directed to like operational steps and a repetitive description will be omitted to avoid the complexity of description. As shown in FIG. 9, it is at first determined whether or not the shutter release button of the digital camera 10 is depressed to its full stroke (step S10). If the shutter release button is in its full stroke position, S2 (YES), the operation proceeds to step S22 of comparing the ISO sensitivity set in the digital camera 10 with the sensitivity threshold value for determination. If the shutter release button is not in its full-stroke position, S2 (NO), then the operation returns to step S10 of determining whether or not the shutter release button of the camera 10 is depressed to its full stroke.

It is then determined whether or not the ISO sensitivity set in the digital camera 10, that is, the ISO sensitivity used for photographing, is lower than the sensitivity threshold values (step S22). If the ISO sensitivity used for photographing is higher than or equal to the sensitivity threshold values (YES), the operation proceeds to step S12 of sending an exposure timing signal including an instruction on the idle transfer. If the ISO sensitivity used for photographing is below the sensitivity threshold values (NO), the operation proceeds to step S12a of sending another exposure timing signal not including the instruction on the idle transfer. Since the determination on the ISO sensitivity for photographing is fixed in advance as is different from the photographing conditions in exposure, the necessity of the compensation of the vertical shading can be determined before the exposure.

After that, the timing signal of the exposure, including an instruction of the idle transfer is transferred (step S12), step S14 of exposure and step 16a of idle transfer are performed. Although not specifically illustrated, step S18 of preprocessing and step S20 of buffering are performed on the idle transferred data. If the idle transfer is not included, the operation proceeds to step S12a of sending the timing signal of the exposure without idle transfer, followed by step S14 of the exposure and step S16b of read-out transfer (to).

The signal charge is then read out into the vertical transfer path 40 and is transferred. This transfer is to transfer signal charges actually obtained by the exposure for shooting an image. The image pickup section 14 converts the transferred signal charges to the corresponding analog signal 54 and outputs the latter to the preprocessor 16. After that, step S18 of preprocessing and step S20 of buffering are performed.

It is then determined whether or not the idle transfer has been done (step S32). If the idle transfer is done (YES), the operation proceeds to step S24 of calculating or formulating the profile of vertical shading. If the idle transfer is not done (NO), the operation proceeds to the normal signal processing flow and comes to end after the processing.

In the calculation, the profile of vertical shading is determined on the basis of the idle transfer data (step S24), and the correction is performed by subtracting part corresponding to the dark current from the image data as mentioned before (step S26). After the correction, the operation proceeds to the normal signal processing flow, and comes to end after the processing. The operation conducted in this manner allows a proper image correction to be rendered to the data of an image while the pattern of exposure timing without involving the idle transfer, when not compensating, is applied to the operation.

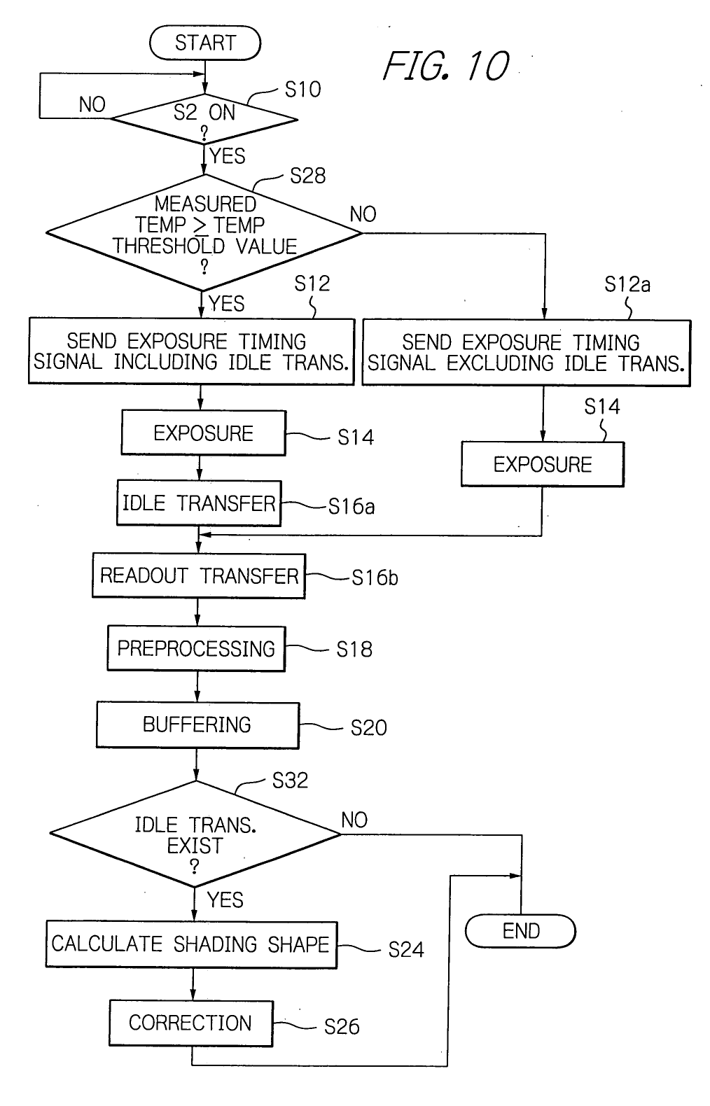

In this case also, the comparison determination step S22 shown in FIG. 9 may be conducted to temperature rather than the ISO sensitivity for imaging. More specifically as shown in FIG. 10, the necessity of compensating for the vertical shading is determined according to the temperature. In this modification, since there are used no parameters based on the exposure, the necessity of the compensation can be determined before exposure. Therefore, when the correction is not performed, the pattern of exposure timing signal without the idle transfer may be used, thus increasing the operational speed. The full-stroke depression, S2, for actual image shooting is detected at step S10, and the photographing conditions are decided. Thereafter, the temperature threshold value stored in the system controller 24 is read out and then compared with a temperature measured (step S28). In dependent upon whether or not the temperature measured at the time of photographing is lower than the temperature threshold value, the pattern of exposure timing signal to be sent is selected.

The operation state above makes it possible to conduct operation, when the correction is not performed, by the pattern of exposure timing signal not including the idle transfer, and hence the operational speed can be increased.

Well, the operation of the idle transfer in the digital camera 10 will be described more specifically. As described above, the idle transfer to determine the profile or outline of vertical shading is carried out by the same operation as the signal charge transfer, and hence the transfer period of time increases by the time for transferring one field of charges. Such an increase in time does not raise any problem in exposure of a single frame of image, but affects continuous, or multiple, exposure performance. It is therefore desirable to control this effect on the continuous exposure performance.

The aforementioned operating procedure may be modified, when the idle transfer is carried out, in such a manner that the system controller 24 controls the supply of the control signal 82 to the timing signal generator 26 as a clock control signal so as to increase the drive frequency during the idle transfer period.

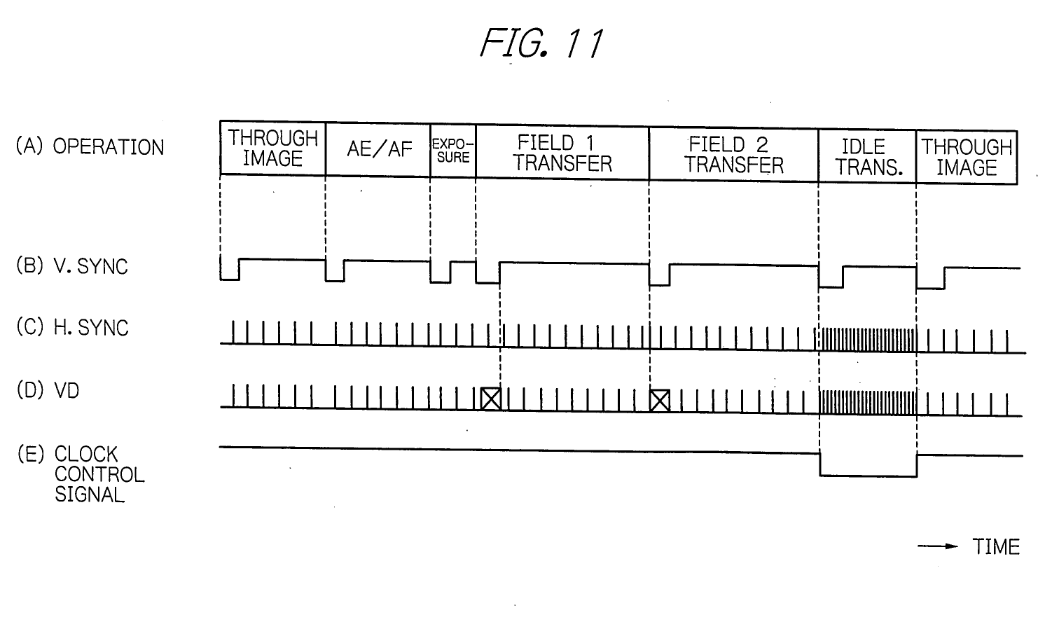

More specifically, FIG. 11 shows how the horizontal synchronous signal H. Sync, shown in part (C), differs according to the operation proceeding. It can be seen that the vertical drive signal shown in part (D) differs accordingly in timed with the horizontal synchronizing signal H. Sync. The driving control in that manner causes the clock control signal shown in part (E) to be supplied to the timing signal generator 26, which in turn changes the drive frequency to be generated accordingly.

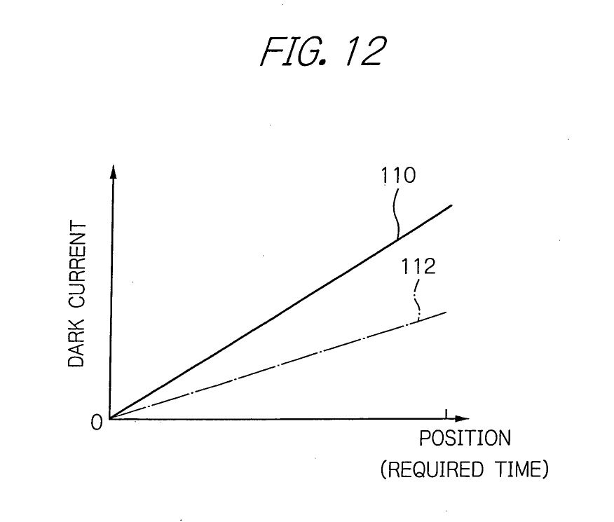

The drive frequency to be generated by the timing signal generator 26 is set beforehand to 24 MHz for the image data transfer and to 48 MHz for the idle transfer with the illustrative embodiment. By doing so, as shown in FIG. 12, the dark currents caused in the image data transfer and the idle transfer may be plotted by a straight line 110 and a broken line 112, respectively. The relationship of the generated dark currents thus exemplified tenders the correction amount of the vertical shading equal to 48/24=2. More specifically, the compensation of the vertical shading is calculated by the expression: (idle transfer drive frequency)/(image data transfer drive frequency)−(amount of the dark current in the image data transfer)/(amount of the dark current in the idle transfer)

In this manner, the digital camera 10 acquires data with the drive frequency increased in the idle transfer, and uses the ratio in drive frequency of the idle transfer to the signal charge transfer to compensate for the vertical shading, the compensated vertical shading being used for correcting the data of an image. That allows the idle transfer period of time may be reduced to half.

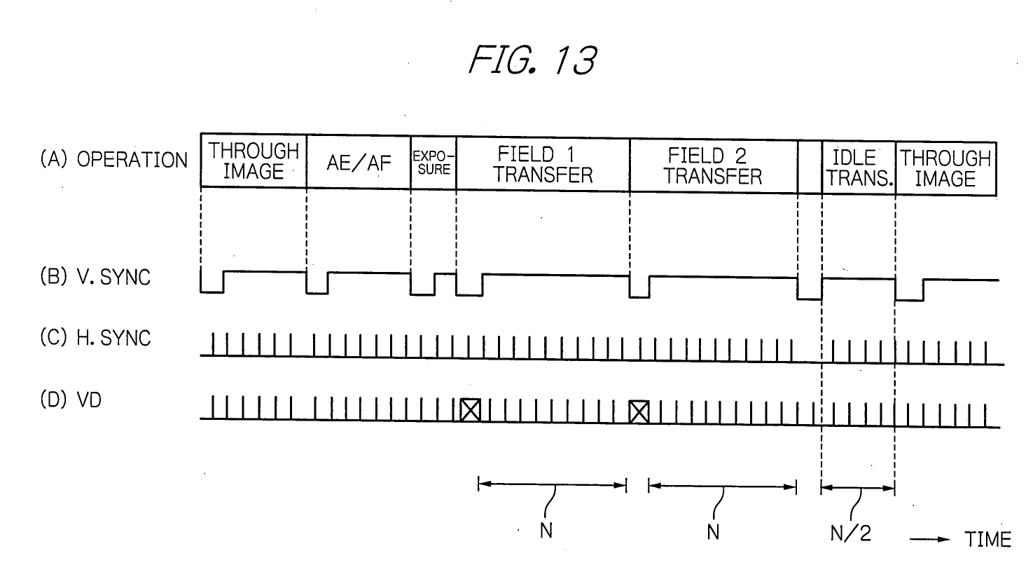

The idle transfer in the digital camera 10 is not limited to controlling the drive frequency in the idle transfer, but may be applied to controlling the number of steps of the idle transfer. It is apparent that the number of transferring steps, or pulses, depends upon the idle transfer duration, or period of time. As shown in FIG. 13, in the digital camera 10 having the number of transfer pulses for the image data transfer set to an integer N, the number of transfer pulses for the idle transfer is equal to N/2.

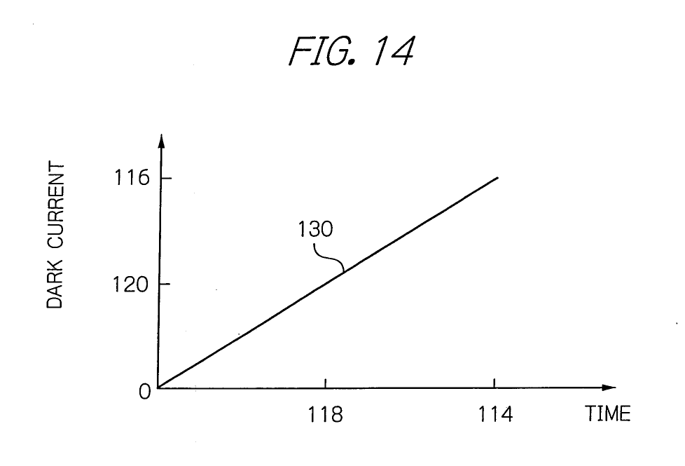

As shown in FIG. 14, the dark current is proportional to the transfer period of time and is therefore represented by a straight line 130. At a time point 114 corresponding to the number of transfer pulses or steps N for the image transfer, the amount of dark current is equal to a value represented by a reference numeral 116. At another time point 118 corresponding to the number of transfer pulses N/2 for the idle transfer, the amount of dark current is equal to a value represented by a reference numeral 120, that is, half as much as the dark current 116 in the image transfer. It is therefore preferable to calculate, for example, 1000 pixels on the basis of 200 pixels in the vertical direction.

The correction amount of the vertical shading is calculated from the ratio in number of transfer pulses or steps of the image data transfer to the idle transfer. Specifically, the correction amount is equal to (number of transfer steps for image data transfer)/(number of transfer steps for idle transfer)=N/(N/2)=2.

In this manner, data of the idle transfer is obtained with the idle transfer steps deducted from the vertical transfer steps, and the ratio in number of transfer steps of the idle transfer to the normal signal charge transfer is used for compensating for the vertical shading, the thus compensated vertical shading being used for correcting actual pixel data transferred. In this manner, the vertical shading is compensated for, and consequently the data of an image is corrected, thus effectively reducing the idle transfer time to half.

The entire disclosure of Japanese patent application No. 2006-126415 filed on Apr. 28, 2006, including the specification, claims, accompanying drawings and abstract of the disclosure is incorporated herein by reference in its entirety.

While the present invention has been described with reference to the particular illustrative embodiment, it is not to be restricted by the embodiment. It is to be appreciated that those skilled in the art can change or modify the embodiment without departing from the scope and spirit of the present invention.

What is claimed is:

1. An image pickup device comprising:
a solid-state image sensor including a bi-dimensional array of photosensitive cells for photo-electrically converting incident light from an object field to corresponding signal charge, a vertical transfer path adjacent to the photosensitive cells for transferring the signal charge in a vertical direction, and a horizontal transfer path for transferring the signal charge in a horizontal direction substantially perpendicular to the vertical direction;
a controller for generating a control signal for controlling operation of said solid-state image sensor;
a timing generator for generating a timing signal in response to the control signal;
a drive generator for generating a drive signal in response to the timing signal; and
a signal processor for processing of image data supplied from said solid-state image sensor,
said controller generating the control signal for reading out the signal charge from said solid-state image sensor according to at least either one of a photographing condition and status, and controlling idle transfer in said vertical transfer paths and transfer of the signal charge,
said signal processor including a shading corrector for determining a profile of vertical shading based on a dark current signal obtained by the idle transfer from said solid-state image sensor,
said shading corrector using the profile of vertical shading determined to correct data of an image actually captured.

2. The device in accordance with claim 1, wherein said controller generates the control signal for carrying out the idle transfer on said vertical transfer path before or after the transfer of the signal charge.

3. The device in accordance with claim 1, wherein said controller generates the control signal additionally serving as sweeping out smear in the idle transfer on said vertical transfer path.

4. The device in accordance with claim 1, wherein said controller generates the control signal for correcting the data of the image when an optical sensitivity set as the photographing condition is higher than a sensitivity threshold value, and for avoiding the data of the image from being corrected when the optical sensitivity set is not higher than the sensitivity threshold value.

5. The device in accordance with claim 1, further comprising a temperature sensor for determining internal temperature of said device.

6. The device in accordance with claim 5, wherein said controller generates the control signal for correcting the data of the image when the temperature determined is higher than a temperature threshold value, and for avoiding the data of the image from being corrected when the temperature determined is not higher than the temperature threshold value.

7. The device in accordance with claim 1, wherein said controller determines a gradient of the profile of vertical shading as the photographing condition, and generates the control signal for correcting the data of the image when the gradient is larger than a gradient threshold value and for avoiding the data of the image from being corrected when the gradient is not larger than the gradient threshold value.

8. The device in accordance with claim 1, wherein said controller provide said timing generator with the control signal for causing said timing generator to generate the timing signal for carrying out the idle transfer when an optical sensitivity set in advance as the photographing condition is higher than a sensitivity threshold value, and for causing said timing generator to generate the timing signal for carrying out the transfer of the signal charge when the optical sensitivity set is not higher than the sensitivity threshold value,
said controller generating the control signal for correcting the image data according to a condition of the idle transfer and avoiding the image data obtained through the transfer of the signal charge.

9. The device in accordance with claim 1, further comprising a temperature sensor for determining internal temperature of said device,
said controller providing said timing generator with the control signal for causing said timing generator to generate the timing signal for carrying out the idle transfer when the temperature determined as the photographing condition is higher than a temperature threshold value, and for causing said timing generator to generate the timing signal for carrying out the transfer of the signal charge when the temperature is not higher than the temperature threshold value,
said controller generating the control signal for correcting the image data according to a condition of the idle transfer and avoiding the image data obtained through the transfer of the signal charge.

10. The device in accordance with claim 1, wherein said controller generates the control signal for raising a first drive frequency of said timing generator for the idle transfer to a value higher than a second drive frequency of the transfer of the signal charge,
said shading corrector correcting the profile of the vertical shading with a ratio of the first drive frequency to the second drive frequency to correct data of an image.

11. The device in accordance with claim 1, wherein said controller generates the control signal for causing said timing generator to render a first number of steps of the idle transfer smaller than a second number of steps of the transfer of the signal charge,
said shading corrector correcting the profile of the vertical shading with a ratio of the second number to the first number to correct data of an image.
